(19) United States
(12) Patent Application Publication
(10) Pub. No.: US 2009/0279100 A1
(43) Pub. Date: Nov. 12, 2009

(54) SCALE AND READHEAD

(75) Inventors: David Roberts McMurtry, Dursley (GB); Alan James Holloway, Wotton-under-Edge (GB); Jason Kempton Slack, Bristol (GB); Marcus Ardron, Stroud (GB); James Christopher Reynolds, Stroud (GB)

Correspondence Address: OLIFF & BERRIDGE, PLC, P.O. BOX 320850, ALEXANDRIA, VA, 22320-4850, US

(73) Assignee: RENISHAW PLC, Wotton-Under-Edge (GB)

(21) Appl. No.: 12/308,951

(22) PCT Filed: Jul. 9, 2007
(86) PCT No.: PCT/GB2007/002546

§ 371 Date: Dec. 30, 2008

(30) Foreign Application Priority Data
Jul. 13, 2006 (GB) 0613902.6

(51) Int. Cl. G01D 5/38

(52) U.S. Cl. 356/499

(57) ABSTRACT

An optical element has a member having features which interact with incident light to produce two or more resultant beams. The configuration of the optical element is such that light which interacts with said features when passing through the member from a first side to produce two or more resultant beams does not interact with said features when returned to another side of the member and/or vice versa. The optical element may be used in a readhead of a scale and readhead apparatus.

The present invention relates to a scale and readhead apparatus. More particularly, the present invention relates to a scale and readhead suitable for incremental scales.

A known form of opto-electronic scale reading apparatus for measuring relative displacement of two members comprises a scale on one of the members, having scale marks defining a periodic pattern and a readhead provided on the other member. The readhead includes a light source for illuminating the scale and diffraction means, for example an index grating and an analyser grating to produce interference fringes in the readhead. Relative movement between the scale and readhead causes the interference fringes to move relative to the readhead. Detecting means in the readhead are responsive to the movement of the fringes producing a measure of the displacement.

European Patent EP 1447648 discloses a photoelectric encoder with a scale, a lens, an aperture and a detector. A grating is located between the aperture and the detector.

A first aspect of the present invention provides an optical element comprising:
a member having features which interact with incident light to produce two or more resultant beams;
wherein the configuration of the optical element is such that light which interacts with said features when passing through the member from a first side to produce two or more resultant beams does not interact with said features when returned to another side of the member and/or vice versa.

This system can be embodied without a Moire grating in front of the detector which can cause mechanical problems.

The index member features may be arranged to diffract incident light in such a way as to maximise any two plus and minus orders. Preferentially these would be symmetric orders.

The member may comprise a phase grating which is provided with features comprising grating regions interspersed with plain regions. The member may have a phase or amplitude grating structure configured to allow light of the zeroth order to pass through.

The member may be provided with alternate transparent regions which allow transmission of incident light through the index member and opaque regions which do not. The transparent regions may comprise refractive elements. The opaque regions may be reflective or absorbent.

The arrangement of the transparent and opaque regions and the angle of incident light may be such that light incident on one side of the member is directed through the transparent regions towards the features, and wherein light returned to another side of the member passes between the features and through the transparent regions.

The member may comprise a birefringent grating. The member may have grating regions filled with a birefringent material. The member may behave like a phase grating to one polarisation of light but appear to be planar to light polarised orthogonally.

A second aspect of the present invention provides a scale and readhead apparatus including the optical element according to the first aspect of the invention.

A third aspect of the invention provides a scale and readhead apparatus comprising:
a scale and readhead, moveable relative to one another;
a light source;
a detector;
an index member located between the light source and the scale, the index member having features which interact with light to produce two or more resultant beams;
wherein the light passes through the index member both on its path from the light source to the scale and also on its path from the scale to the detector; and
wherein the configuration of the index member is such that light which interacts with said features when passing through the member from a first side to produce two or more resultant beams does not interact with said features when returned to another side of the member and/or vice versa.

The arrangement of the index member may be such that said features interact with light passing through the index member on its path from the light source to the scale but do not interact with light on its path from the scale to the detector.

The features may interact with incident light to cause diffraction of said light.

Preferably the index member comprises the optical element according to the first aspect of the invention.

The index member may comprise a birefringent grating and a quarter waveplate may be provided between the index member and the scale.

A lens may be provided between the index member and the detector. A spatial filter may be provided between the index member and the detector.

In one embodiment, the lens comprises a microlens array provided between the index member and detector. The microlens may comprise a first lens, a second lens and a filter between them. The period of the filter and lens array is preferably an integer multiple of the period of fringes formed at the detector. A double micro-lens array may be provided to produce non inverted image segments. In this case the period of the lens array need not be an integer multiple of the fringe period.

The detector may be a structured detector comprising an array of photosensitive elements. The separation of the photosensitive elements of the structured detector may match the non linear separation of fringes formed at the detector. An analyser grating may be provided in front of the detector. A field flattening lens may be provided in front of the detector.

Preferred embodiments of the present invention will be illustrated by way of example with reference to the accompanying drawings, wherein:

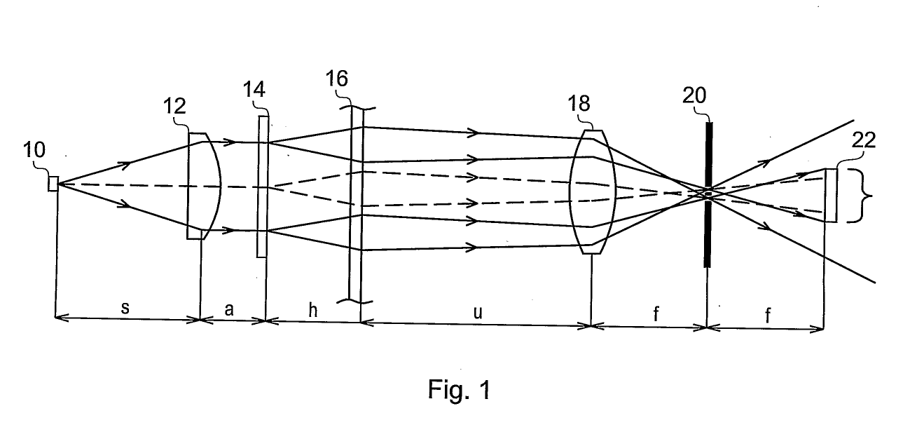

FIG. 1 is a schematic illustration of the invention in transmissive mode;

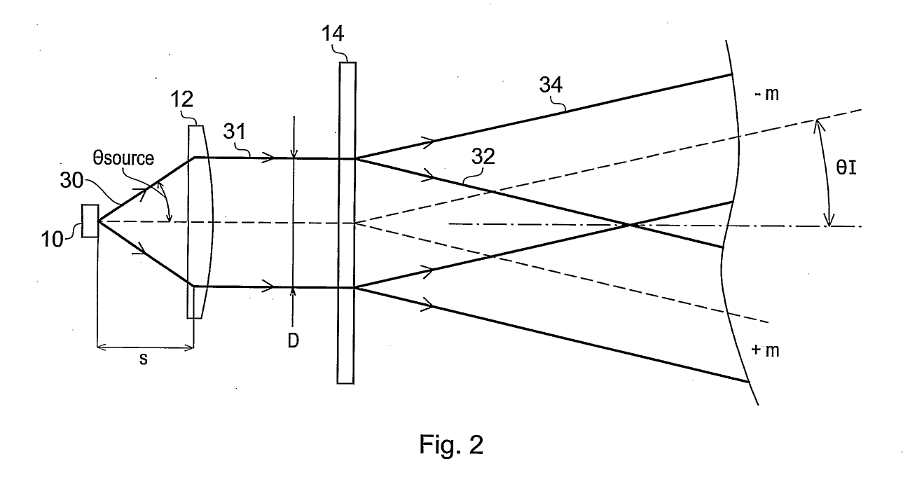

FIG. 2 shows a detailed view of the light source and index member of FIG. 1;

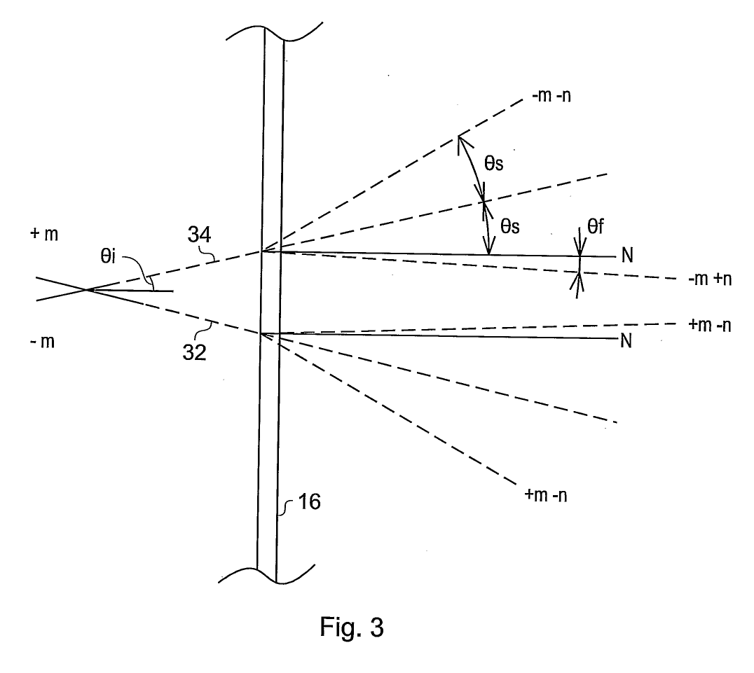

FIG. 3 illustrates a detailed view of the index member of FIG. 1;

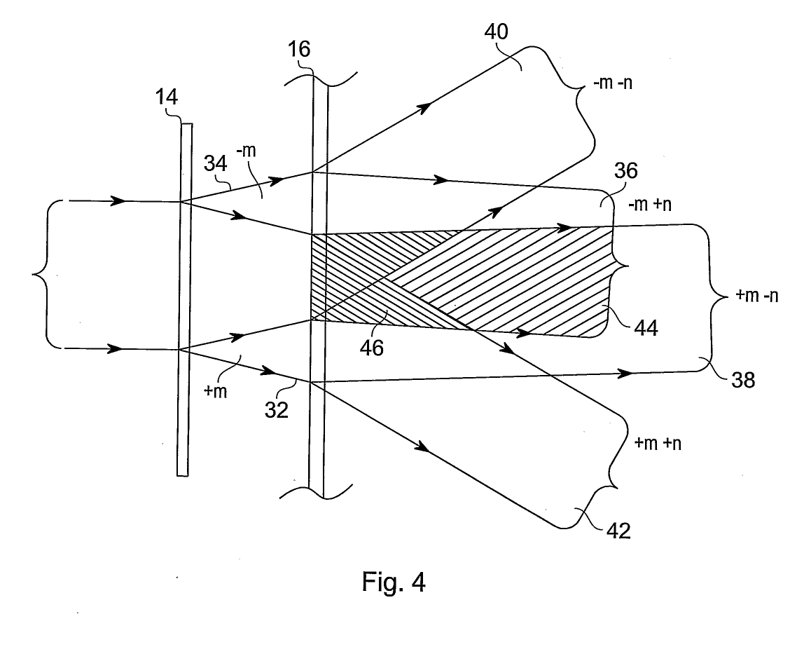

FIG. 4 illustrates a detailed view of the index member and scale of FIG. 1;

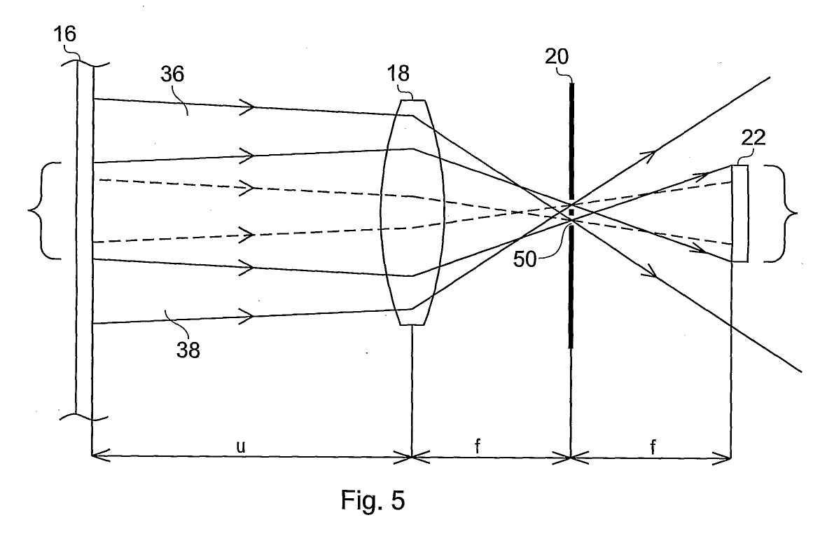

FIG. 5 illustrates a detailed view of the lens and filter of FIG. 1;

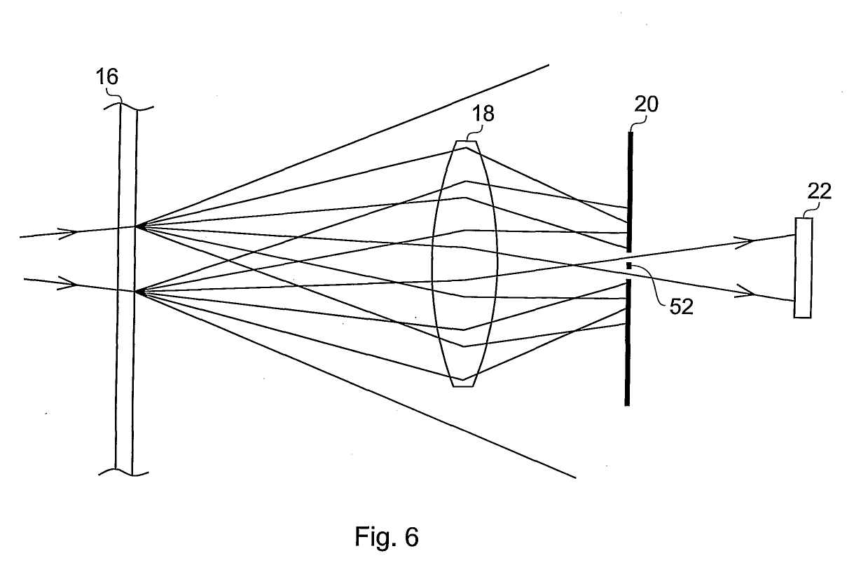

FIG. 6 illustrates a second detailed view of the lens and filter of FIG. 1;

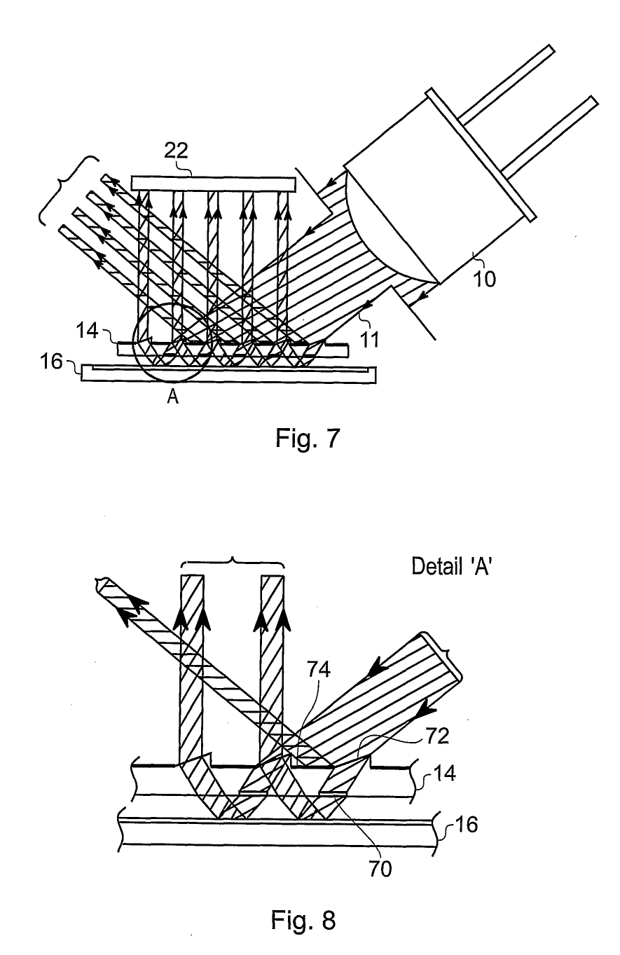

FIG. 7 is a first alternative embodiment of the scale and readhead;

FIG. 8 is a detail of the index member of FIG. 7;

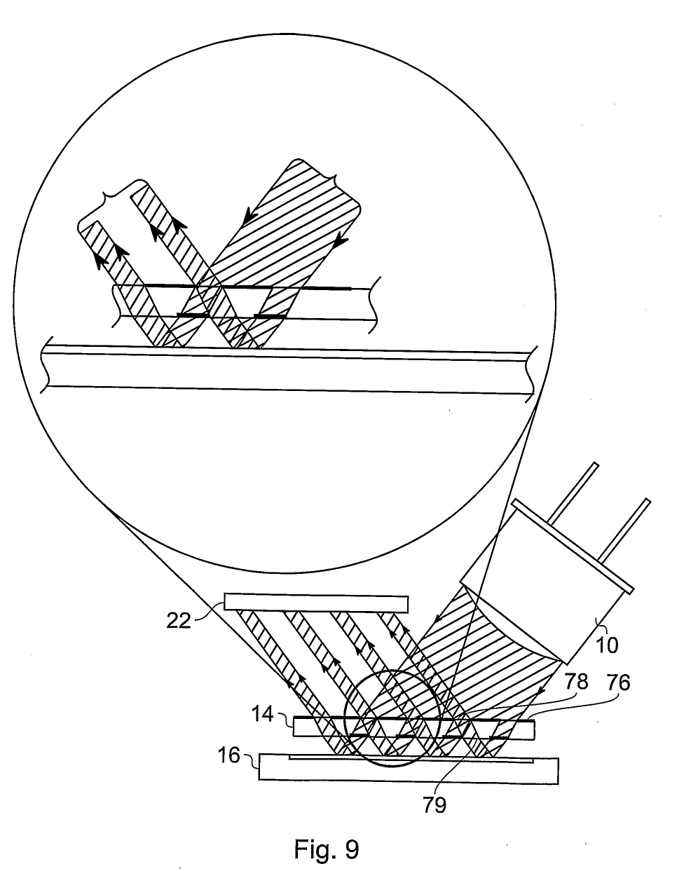

FIG. 9 is a second alternative embodiment of the scale and readhead;

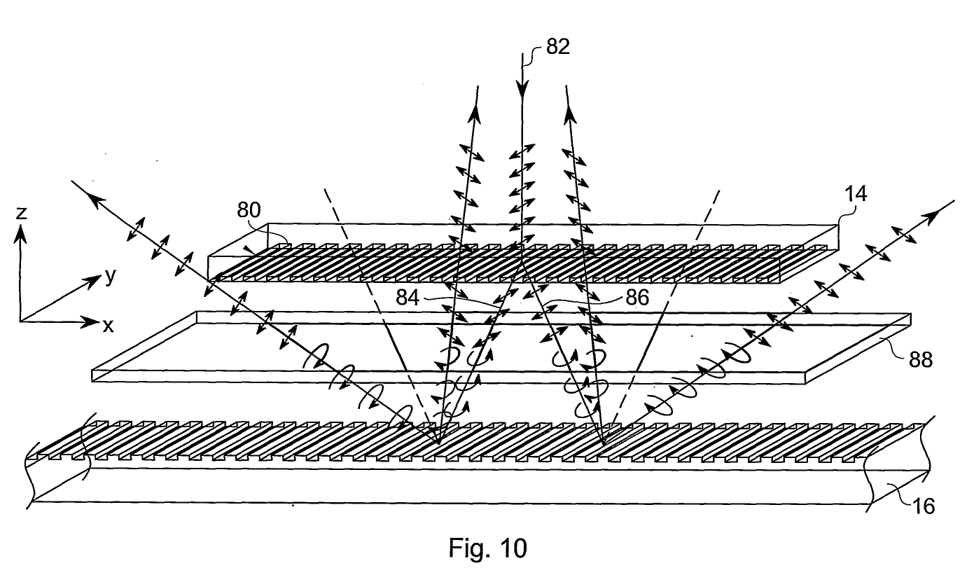

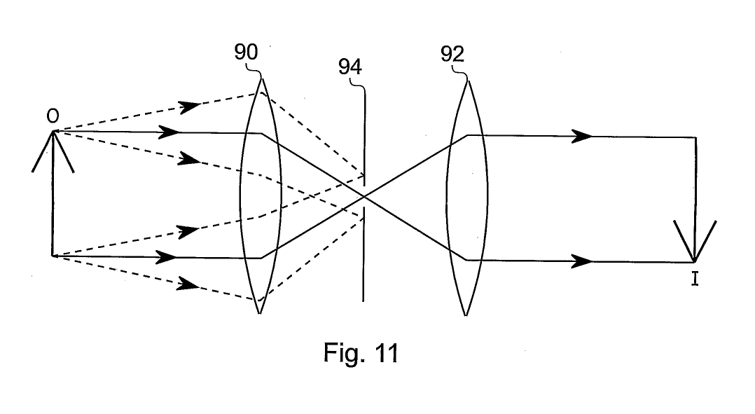

FIG. 10 shows a birefringent index member;

FIG. 11 illustrates a lens and filter arrangement;

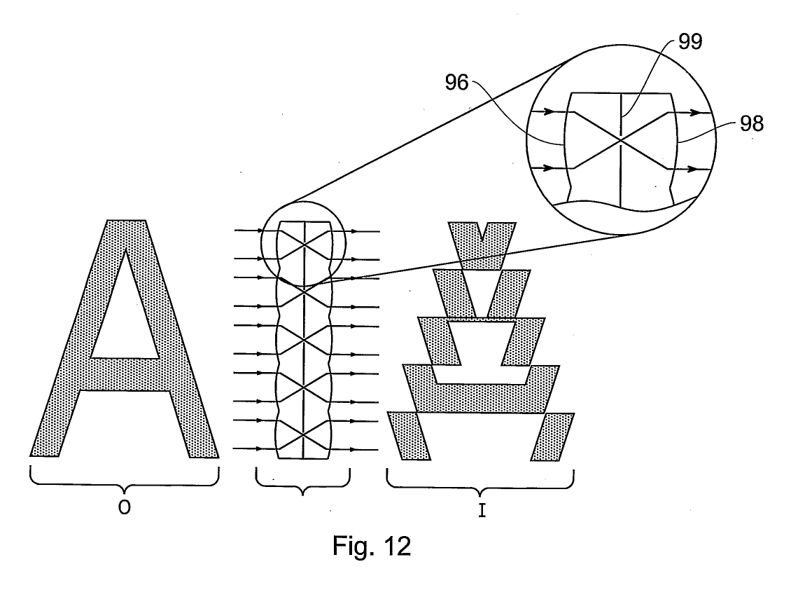

FIG. 12 illustrates a microlens and filter array;

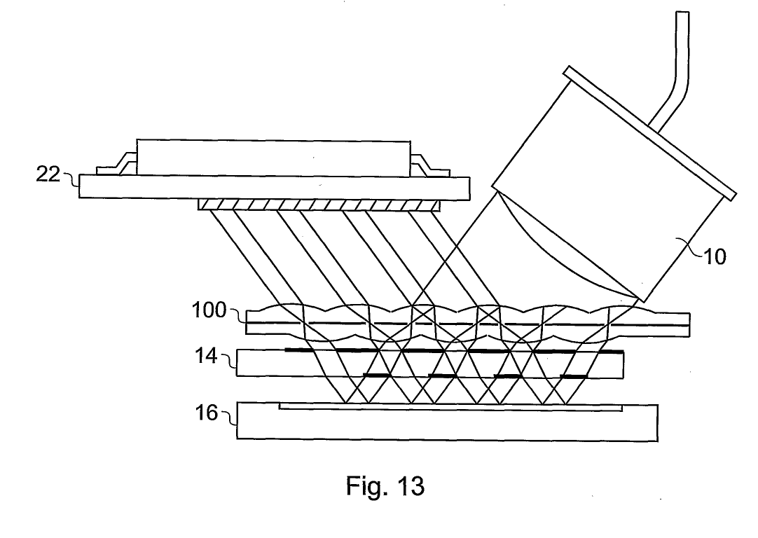

FIG. 13 illustrates a reflective arrangement of the scale and readhead incorporating a microlens and filter array;

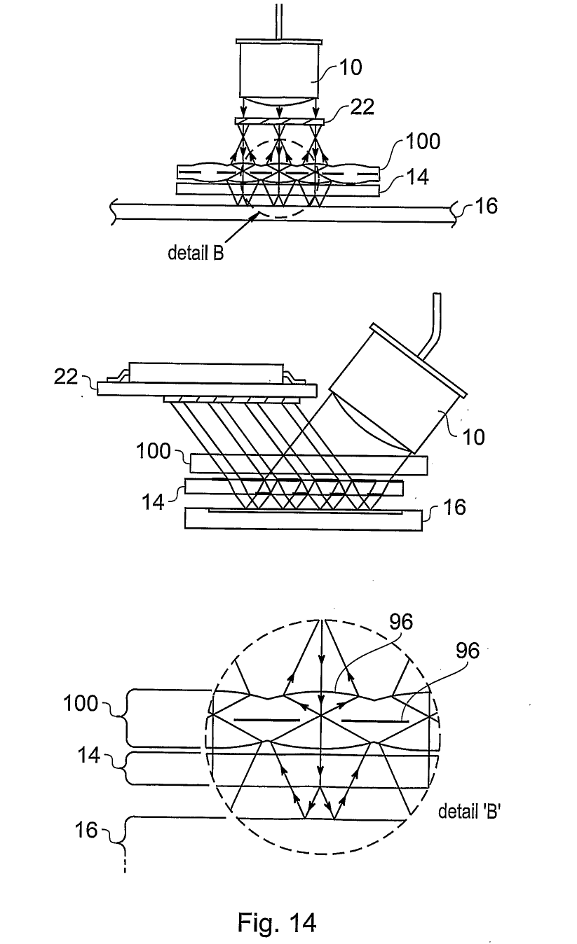

FIGS. 14a-c are side, end and detailed views illustrating a reflective arrangement of the scale and readhead incorporating a microlens and filter array with cylindrical lenses;

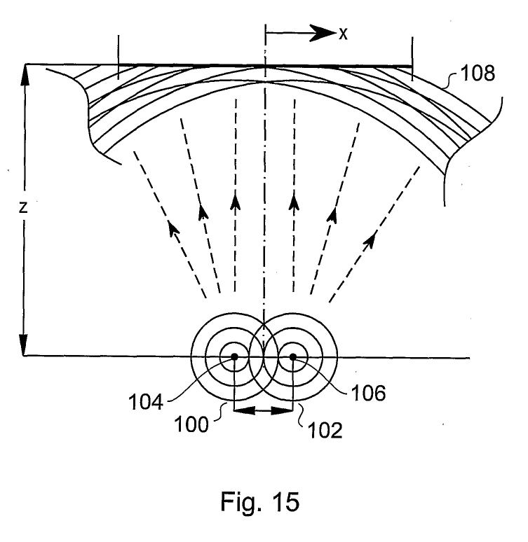

FIG. 15 illustrates the fringe field produced from two spherical wavefronts;

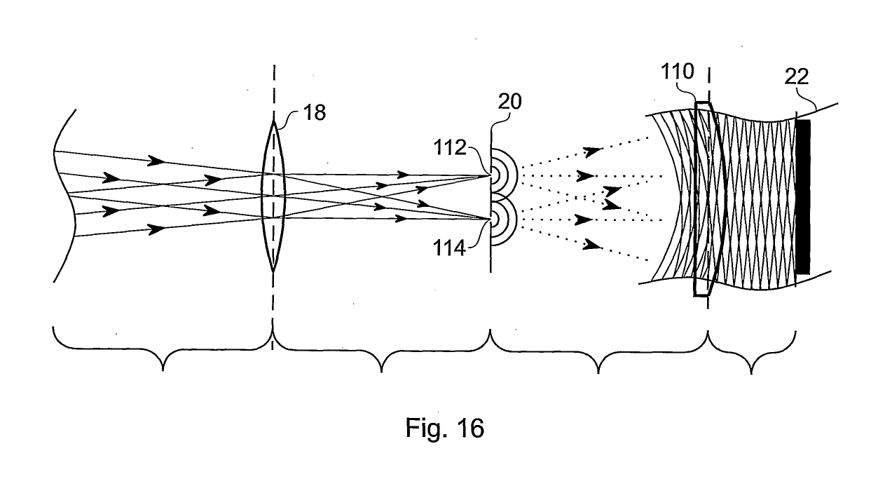

FIG. 16 illustrates a field flattening lens; and

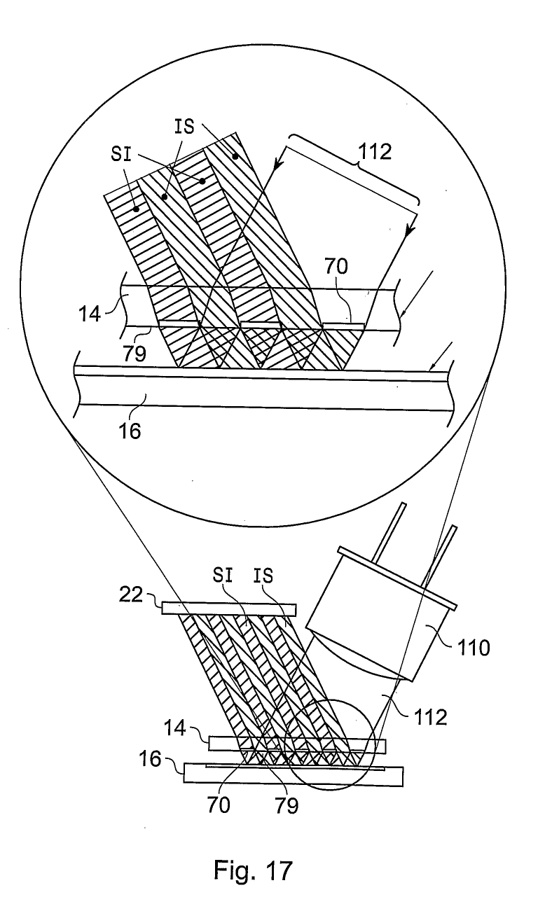

FIG. 17 shows an alternative embodiment to that illustrated in FIG. 9, which products interleaved fields of fringes.

FIG. 1 illustrates a transmissive embodiment of the scale and readhead apparatus. A transmissive arrangement will typically comprise a housing (not shown) containing the optics of the system, the housing having a slot for the scale to pass through. In this way the scale is movable relative to the optics in the housing.

A light source 10 and source lens 12 are arranged to produce a light beam incident on an index member 14. The index member 14, which in this case comprises an index grating, splits the incident light beam into diffracted orders which are themselves incident on the scale 16. Two dominant overlapping wavefronts are thus incident at the scale and interfere to form a set of fringes. An imaging lens 18 is used to steer the wavefronts and focus them through a filter 20. Resultant fringes are detected at a detector 22.

The different elements of the scale reading apparatus will now be described in more detail.

FIG. 2 illustrates the light source 10 and index member 14 (in this embodiment an index grating) in more detail. The light source may comprise a small area light source such as VCSEL, point source LED, laser diode or RCLED. This light source creates a diverging beam of light 30 which is collected by lens 12 which gives a divergent, convergent or collimated beam. The beam diameter D is determined by the divergence θ_{source} of the beam from the light source 10 and the distance S between the source 10 and the lens 12, the diameter of the lens or any other pupil or aperture, the separation between the lens 12 and index member 14 and the level of collimation from the lens. The light beam incident on the index member 14 is diffracted into a plurality of orders by the index member. The parameters of the index member such as the depth and profile of its features, the refractive index, and incident wavelength are chosen to maximise two symmetric diffraction orders and to minimise others. Thus FIG. 2 shows only two beams 32,34 relating to the plus and minus m^{th} diffraction order.

For an index grating of period P_{I}, the m^{th} diffraction orders will diverge at an angle θ_{I} from the normal of the index plane, where θ_{I}≈mλ/P_{I}.

FIG. 3 illustrates the scale of the apparatus. Two diverging beams 32,34 are incident on the scale. These beams are a diffraction pair from the index member. Although the diverging beams 32,34 are shown as a symmetric pair in FIG. 3, any two orders may be used. These two orders could be asymmetric and/or from the same side of the zeroth order. The embodiments described herein refer to symmetric plus and minus orders for ease of illustration, but any two orders could be used. As with the index member, the parameters of the scale are chosen to minimise all but two symmetric orders. The beams incident on the scale are diffracted into two key components. The plus and minus symmetric diffraction orders from each of beams 32,34 are shown along with the zeroth for reference. These diffraction orders are angled at θ_{S} from the direction of the incoming beam, where θ_{S}≈nλ/P_{S}, where P_{S} is the period of the scale grating. This equation is true where the incident angle θ_{I} is small. The angle between each of the two converging orders at the detector and the normal to the scale plane is θ_{f}. Fringes are formed at the overlap of these two convergent orders, the fringes having a period of P_{f}≈λ/2θ_{f}. In order to obtain two converging diffraction orders P_{I} must be greater than P_{S}. However diverging beams at the same angle (θ_{f}) will generate the same fringe pattern.

FIG. 4 illustrates the diffraction orders created at the scale. This diagram shows the plus and minus diffraction orders from each of the illumination beams 32,34. Fringes are formed in the region 44 by the overlapping beams 36 and 38 where 36 is the +n diffraction order from 34 and 38 is the −n diffraction order from 32. However the region with the cross-hatching 46 also includes fringes from the overlap of other orders and these are not used.

FIG. 5 illustrates the imaging lens, filter and detector. The lens 18 is used to relay the orders from the scale 16 to the detector 22. (However this lens is optional.) The fringes at the detector 22 represent the filtered beat pattern at the scale 16. The spatial filter 20 serves to filter out unwanted orders, so that only the fringes from interference between the symmetric plus and minus diffraction orders of interest are detected. Where the zeroth order has not been suppressed by the index and scale gratings 14,16, the spatial filter 20 must also filter out the zeroth order.

The filter 20 is positioned at the conjugate to the source. Light at the aperture of the spatial filter 20 can be described as images of the light source 10. The two orders 36,38 are focused at the filter apertures and effectively form two point sources. Light from these adjacent effective sources overlap to form fringes. The detector 22 is positioned to detect these fringes.

FIG. 6 shows the lens 18 and filter 20 in more detail. Some of the high orders diffracted from the scale 16 miss the lens 18 and so are not directed towards the filter. Other unwanted orders which are directed by the lens 18 to the filter 20 are blocked. In this Figure a DC/low order block 52 is included to block the zeroth diffraction order (not shown). Thus only the selected orders pass through the filter 20.

An appropriate choice of index member period (for a given scale period) allows the fringes to be coarse enough to be detected directly by a structured detector without requirement for a Moire grating. A suitable structured detector is described in European Patent No. 0543513.

This arrangement has the advantage that variation in the pitch angle of the scale results in only a small cosine error in the period of the fringes at the detector. This has the resulting advantage that if the scale is not completely flat there is no significant error in fringe period. If the scale is imaged onto the detector then fringe position is constant with variation in scale angular pitch.

It is not always convenient to use a scale measurement system which works in transmission. However in converting this system to a reflective system, it is difficult to avoid passing the light through the index member on its return path from the scale due to the need to keep a small scale to index clearance in order to maintain good overlap between the scale illumination beams.

The following embodiments are reflective systems in which light passes through an index member both on its way to and on return from the scale but is diffracted only on the first pass.

It is advantageous if the index member separates the light into wanted and unwanted regions and directs the unwanted light away from the detector.

FIG. 7 illustrates an embodiment of the index member in a reflective arrangement. A light source 10 projects a beam of light which passes through an aperture 11 to prevent stray light at the detector. The beam of light passes through the index member 14 to the scale 16. Light from the scale 16 passes undiffracted through the index member 14 back towards to the detector system 22. (The lens and filter are not shown for clarity.) In this embodiment the index member is configured so that unwanted light reflected off the top surface of the index member is diverted away from the detector system.

An index member suitable for use in the arrangement of FIG. 7 is illustrated in more detail in FIG. 8. FIG. 8 corresponds to the section marked ‘A’ in FIG. 7. The lower surface of the index member is provided with a series of grating regions 70. However the upper surface of the index member is provided with alternate structured prism elements 72 and coated surfaces 74, (e.g. chrome or single or multi layer thin film coatings). The structured prism elements 72 are, transparent and the intervening flat surfaces 74, are coated, and reflective. Alternatively, an absorbent material may be used in place of a reflective material. As can be seen in FIG. 8, light from the light source is incident on the index member. The light which is incident on the coated surfaces 74 is reflected away from the detection system whilst the light which is incident on the structured prism elements 72 passes through the index member then interacts with and is diffracted by the grating surface 70 on the lower surface and passes on to the scale. Light returning from the scale misses the grating segments 70 and passes to the detector. Thus the relative positions of the structured prism elements 72 and the grating sections 70 are important, as well as the illumination angle and prism angle.

Whilst FIG. 8 illustrates the index member 14 including the structured prism elements 72, these may be provided separately to the index member.

The angle of the incident light on the index member must be arranged so that the incident light is not simply reflected off the prism elements. Suitable single or multi layer coatings may be added to the prism surfaces to maximise transmission.

Another embodiment of an index member suitable for use in a reflective system is illustrated in FIG. 9, which shows a side view and an enlarged section of the scale and index member. As before the lower surface of the index member 14 is provided with grating segments 70. The upper side of the index member is provided with alternate light absorbing regions 76 and non absorbent regions 78. As illustrated in FIG. 9, light from the light source 10 is either incident on the absorbent regions 76 or the non-absorbent regions 78 of the upper surface of the index member 14. The light incident on the absorbent regions 76 is absorbed, whilst light incident on the non-absorbent regions 78 is transmitted through the index member 14 where it meets and is diffracted at the grating segments 70. Light returning from the scale 16 passes through the transmissive regions 79 between the grating segments 70 and through the non absorbent regions 78 towards the detector (i.e. and misses the grating segments on the return path from the scale). The absorbent regions may be replaced with reflective regions, light reflected off these regions being directed away from the detector.

In the embodiments described in FIGS. 7-9, the index member has a surface with grating members interspersed with plain regions. This arrangement allows the DC to pass through the plain region of the index member. The grating regions are full depth (optically λ/2) compared to the surrounding material. Alternatively, the index member could have a non segmented phase grating structure (i.e. without plane regions) configured with an alternative phase depth which allows the zeroth order to pass through.

FIG. 10 illustrates an embodiment in which the index member 14 comprises a birefringent grating. The index member 14 has grating regions 80 filled with a birefringent material. This index member behaves like a phase grating to one polarisation of light but appears to be planar to light polarised at plus or minus 90°.

As illustrated in FIG. 10, linear polarised light from the light source 82 passes through the index member 14. The combination of the direction of polarisation of the light and orientation of the birefringent material in the grating regions 80 is such that the refractive index of the index member substrate is greater or less than that of the birefringent material. Thus the index member 14 acts as a grating and the light beam is diffracted into a plurality of orders 84,86. In FIG. 10, only the ±1 orders are shown for clarity.

Light that has passed through the index grating 14 then passes through a quarter waveplate 88 orientated so to cause the beams 84,86 to become circularly polarised. This direction of polarisation is reversed on reflection from the scale 16, where diffraction also takes place. As the light 84,86 passes back through the quarter waveplate the light is transformed back to linear polarisation but at right angles to the incoming beam. Thus the light passes straight through the index 14 as if it were a plane unstructured element.

This index member thus acts as an index grating for light approaching the scale from the light source, but acts a plane unstructured element for light reflected from the scale passing back through the index member.

The index member could be formed by filling deeply etched fingers with a birefringent material aligned along or against the grating fingers. Alternatively the index member may be made as a laminated stack with alternate homogenous and birefringent strata.

The imaging lens described in the above embodiments is a large component and has a disadvantage that it does not share a plane with other components. The spatial filter suffers from the same disadvantage.

In an alternative arrangement the lens and spatial filter are replaced by a microlens array. FIG. 11 illustrates a first lens 90, a second lens 92 and a filter 94 between them positioned at the focal point of the two lenses. The spatial filter 94 limits the angle of acceptance of the device. The object O and image I are illustrated in FIG. 11.

The arrangement illustrated in FIG. 11 is used to form a pair of microlens arrays with a structured stop plane (spatial filter). This stop plane could be printed on the back of one array for example. Such a pair of microlens arrays 96,98 with a structured stop plane 99 is illustrate in FIG. 12. This Figure illustrates an object O and its image I. The object O has been split into numerous regions each of which is inverted in the image I. In the optical design illustrated in FIG. 12, each of the two beams of interest is split up and each segment is reversed. If each segment from each beam aligns with its neighbour so that the resulting fringe field is continuous in phase and period, then a full fringe field will result. This is achieved when the period of the filter and lens array is an integer multiple of the fringe period to maintain segment to segment phasing with system misalignment. Thus the period and phase of the fringes remains constant and continuous over the entire field.

Alternatively, a second micro-lens member may be added to re-invert the segmented image and thus reconstruct the original object without restriction on feature period.

FIG. 13 illustrates an embodiment of the apparatus incorporating a microlens and stop composite 100. In the embodiment illustrated, the index member 14 is provided with absorption segments as described in earlier embodiments. The index member 14, microlens array and filter 100 may also be fabricated in one assembly.

FIGS. 14a-c show such an arrangement. FIG. 14a is a side view, FIG. 14b is an end view and FIG. 14c is an enlarged view of detail B in FIG. 14a. An array of cylindrical lenses 96,98 is used so that light is passed straight through the array unmodified in the direction along the grating fingers. In a plane of diffraction, the cylindrical lenses 96,98 focus light onto the filter 99 and off to the detector as the illumination is normal to this plane there is no position offset between top and bottom lens arrays.

In the above embodiments, especially the single lens types, the fringes produced at the detector will not have a constant period. As illustrated in FIG. 15 interference of two spherical wave fronts 100,102 from the point sources 104,106 at the spatial filter, gives a fringe field 108 across which the period varies away from the centre line. If the effective light sources are relatively close together and the image plane is relatively far away, as in Young's slits experiment, the fringes can be approximated to having a constant period in the central region. However, in the arrangement of the present invention, the distance between the image plane (i.e. detector) and the effective light sources (i.e. spatial filter) may not be large in comparison with the distance between the effective light sources. Furthermore, the distance between the spatial filter and the detector is similar to the detector width. Thus the fringe spacing cannot be treated as constant.

A structured detector may be manufactured that matches the fringes over the width of the field.

Alternatively, a detector having a period which matches the fringes can be made by fitting a suitable analyser grating to a structured detector of constant period. This solution modulates the amplitude of the fringes. The structured detector period could be constant and coarse relative to the scale period.

Without an analyser grating, a design may require a spatial filter with two very close holes. The analyser grating has the effect of matching the fringe period to the structured detector thus releasing constraints on the period of the index member. Thus the period of the index member can be set to separate the spots at the spatial filter, thus simplifying the manufacture and opening assembly tolerances.

FIG. 16 illustrates another solution in which a field flattening lens 110 is inserted before the structured detector 22. In a simple embodiment, the source is imaged to a series of points in a plane. Two of these images 112,114 coincide with gaps in the filter 20. If the two source images 112,114 at the filter plane 20 are relatively close together, then a field flattening lens 110 may be used to flatten the wavefronts from the apparent sources. This has the result of producing a constant or slowly varying period fringe field. Light from the point sources 112,114 is collimated so plane waves interfere and give a constant period fringe field at the structured detector. A constant period structured detector may be used to measure this field.

A further embodiment of the invention will be described with reference to FIG. 17, which shows a side view of the embodiment and an enlargement of part of the scale and index member. In this embodiment, the index member 14 is similar to that shown in FIG. 9 with a lower surface having alternating stripes of grating 70 and plain glass 79. However, the top surface of the index member has no features such as the light absorbing regions 76 (shown in FIG. 9).

The index member 14 and scale 16 are illuminated by light 112 from a light source 110 at an oblique incidence. The light 112 passes through the index member 14 to the scale 16. The light source 110 is angled so that light passing through the grating stripe 70 on its first pass through the index member 14 passes through the plain glass 79 stripe on its return through the index member 14 and vice versa. Thus two sets of fringes will result—the ‘index-scale’ fringe IS (i.e. light interacting with the index member and then the scale) and the ‘scale-index’ fringe SI (i.e. light interacting with the scale and then the index member).

These two sets of fringes have the same power and this improves photometry over partially blocking designs. They also have the same period and position but are laterally separated; there will be no interference between them.

As the fringe field here contains interlaced sections of the two types of fringe, the error sensitivity of the system will be the average of the two individual error sensitivities of each fringe field.

This system has the advantage that all the light from the light source can be detected.

1. An optical element comprising:
a member having diffractive features which interact with incident light to produce two or more resultant beams;
wherein the configuration of the optical element is such that light which interacts with said diffractive features when passing through the member from a first side to produce two or more resultant beams, passes through the member but does not interact with said diffractive features when returned to another side of the member and/or vice versa.

2. (canceled)

3. An optical element according to claim 1 wherein said features are arranged to diffract incident light to maximise any two symmetric plus and minus orders.

4. An optical element according to claim 1 wherein the index member comprises a phase grating which is provided with features comprising grating regions and plain regions.

5. An optical element according to claim 1 wherein the index member has a phase grating structure configured with a phase depth which allows light of the zeroth order to pass through.

6. An optical element according to claim 1 wherein the index member is provided with alternate transparent regions which allow transmission of incident light through the index member and opaque regions which do not.

7. An optical element according to claim 6 wherein the transparent regions comprise refractive elements.

8. An optical element according to claim 6 wherein the opaque regions are reflective.

9. An optical element according to claim 6 wherein the opaque regions are absorbent.

10. An optical element according to claim 6 wherein the transparent and opaque regions are arranged such that light incident on one side of the member is directed by the transparent regions towards the features, and wherein light returned to another side of the member passes between the features and through the transparent regions.

11. An optical element according to claim 1 wherein the index member comprises a birefringent grating.

12. An optical element according to claim 11 wherein the index member has grating regions filled with a birefringent material.

13. An optical element to according to claim 11 wherein the index member behaves like a phase grating to one polarisation of light but appears to be planar to light polarised at plus or minus 90°.

14. An optical element according to claim 1 wherein the configuration of the optical elements is such that light interacting with features when passing through the member from a first side does not interact with said features when returned to another side of the member and forms a first set of fringes, and wherein light which does not interact with the features when passing through the member from a first side does interact with said features when returned to said another side of the member and forms a second set of fringes.

15. A scale and readhead apparatus including the optical element according to claim 1.

16. A scale and readhead apparatus comprising:
a scale and readhead, moveable relative to one another;
a light source;
a detector;
an index member located between the light source and the scale, the index member having features which interact with light to produce two or more resultant beams; wherein the light passes through the index member both on its path from the light source to the scale and also on its path from the scale to the detector; and
wherein the configuration of the index member is such that light which interacts with said features when passing through the member from a first side to produce two or more resultant beams, passes through the index member but does not interact with said features when returned to another side of the member and/or vice versa.

17. A scale and readhead system according to claim 16 wherein the arrangement of the index member is such that said features interact with light passing through the index member on its path from the light source to the scale but do not interact with light on its path from the scale to the detector.

18. A scale and readhead system according to claim 16 wherein said features interact with incident light to cause diffraction of said light.

19. A scale and readhead system according to claim 16 wherein the index member comprises an optical element.

20. A scale and readhead according to claim 16 wherein the index member comprises a birefringent grating and wherein a quarter waveplate is provided between the index member and the scale.

21. A scale and readhead apparatus according to claim 15 wherein a lens is provided between the index member and the detector.

22. A scale and readhead apparatus according to claim 16 wherein a spatial filter is provided between the index member and the detector.

23. A scale and readhead according to claim 21 wherein the lens comprises a microlens array provided between the index member and detector.

24. A scale and readhead according to claim 23 wherein the microlens comprises a first lens, a second lens and a filter between them.

25. A scale and readhead according to claim 24 wherein the period of the filter and lens array is an integer multiple of the period of fringes formed at the detector.

26. A scale and readhead according to claim 23 wherein a double micro-lens array is provided to produce non inverted image segments.

27. A scale and readhead according to claim 16 wherein the detector is a structured detector comprising an array of photosensitive elements.

28. A scale and readhead according to claim 27 wherein the separation of the photosensitive elements of the structured detector matches the non constant period of fringes formed at the detector.

29. A scale and readhead according to claim 16 wherein an analyser grating is provided in front of the detector.

30. A scale and readhead according to claim 16 wherein a field flattening lens is provided in front of the detector.

31. A scale and readhead system according to claim 16 wherein the angle of the incident light and the configuration index member is such that light interacting with features when passing through the member from a first side does not interact with said features when returned to another side of the member and forms a first set of fringes, and wherein light which does not interact with the features when passing through the member from a first side does interact with said features when returned to said another side of the member and forms a second set of fringes.

32. A scale and readhead system according to claim 31 wherein the first and second set of fringes are interleaved.
